(19) United States
(12) Patent Application Publication
(10) Pub. No.: US 2004/0047767 A1
(43) Pub. Date: Mar. 11, 2004

(54) Microfluidic channel for band broadening compensation

(76) Inventors: Richard Bergman, Horseheads, NY (US); James M. Egan, Bethlehem, PA (US); Peter J. Kalal, Corning, NY (US); Mark A. Lewis, Corning, NY (US); Mark A. Quesada, Horseheads, NY (US)

Correspondence Address: CORNING INCORPORATED, SP-TI-3-1, CORNING, NY, 14831

(21) Appl. No.: 10/241,885

(22) Filed: Sep. 11, 2002

(51) Int. Cl. B01L 3/00

(52) U.S. Cl. 422/99; 422/100; 204/600

(57) ABSTRACT

A microchannel for analyte band broadening compensation is disclosed. The microchannel includes a bend having an inside radius of curvature, an outside radius of curvature, and a width. The bend is constructed such that the width and either the inside radius of curvature, the outside radius of curvature or both change simultaneously.

### BACKGROUND OF THE INVENTION

1. Field of the Invention

The present invention relates generally to the field of microfluidic devices, and more particularly to a microchannel configuration for redirecting the paths of samples in a manner that compensates for sample dispersion.

While the present invention is subject to a wide range of applications, it is particularly well suited for analyte plug band broadening compensation in electrophoretic separation applications.

2. Technical Background

Microchannel devices are finding increased use in the separation, identification and synthesis of a wide range of chemical and biological species. Such devices, which incorporate microfluidic channel dimensions in the range from a few microns to about 1 millimeter may permit the miniaturization and large-scale integration of many chemical processes in a manner analogous to that already achieved in microelectronics. Applications incorporating such microchannel devices include such diverse processes as DNA sequencing, immunochromatography, the identification of explosives, the identification of chemical and biological warfare agents, and the synthesis of chemicals and drugs.

A promising approach to microscale chemical analysis is electrophoretic separation. In electrophoretic separation, the carrier fluid may be either moving or nearly stationary, and an applied electric field is used to drive ionic species through a gel or liquid. Separation occurs because the ion speeds depend on the unique charge and mobility of each species. Provided the applied field is uniform across the channel cross-section, the ions of the same charge and mobility move at the same speed and so progress along the column without any induced dispersion. Such motion is analogous to the flat velocity profile of an electroosmotic flow, and the various species thus again exhibit unique arrival times at the channel exit. Electrophoretic separations may, however, be severely degraded by diffusion or dispersion. Dispersion may arise not only from non-uniformity of the carrier fluid speed, but may also arise directly from non-uniformity of the electric field across the cross-column section.

Despite these shortcomings, numerous studies have demonstrated the potential benefits of miniaturizing capillary electrophoresis on microfabricated devices. The benefits include, for example, portability, reduced reagent use, and increased opportunities for parallel analysis. Since the separation efficiency of capillary electrophoresis increases with the length of the separation channel, longer channels are generally desirable. Generally speaking, confining such channels to a small area for use in microfluidic devices typically requires configurations with multiple channel turns (e.g., serpentine channels). Unfortunately, such turns generally add dispersion to analyte bands and therefore often reduce the benefits of channel length.

The bends or turns briefly mentioned above typically introduce a phenomenon, which is often referred to as the “race track effect,” in microfluidic channels utilized in high-resolution electrophoretic separations. In essence, the race trace effect results in band broadening in an analyte plug as a result of the plug traversing the bends or turns. More specifically, when an electrophoretic band is migrating through a linear channel, the molecules making up the band, which are all migrating at roughly the same speed, tend to migrate as a tight band. When migrating through a turn in a serpentine pathway, however, the same molecules will tend to migrate through the shorter inner side of the channel faster than the longer outside of the channel, which leads to band spreading and non-uniformity across the width of the channel. Generally speaking, at each turn in the pathway, more band resolution is lost. Accordingly, an initially flat interface will be severely skewed when passing through one or more turns.

Despite these and other shortcomings and given the small size of microfluidic devices, there will likely continue to be a need for microfluidic devices incorporating both multiple channels and/or long lengths of micron-sized channels in order to utilize the maximum amount of space, while possibly reducing the microfluidic device size. What is needed therefore, are improved microfluidic channels having increased length and which include turns or bends that are constructed and arranged to substantially compensate for the analyte plug band skewing (the race track effect) generally experienced by analyte plugs traversing a bend or turn. It is to the provision of such a microchannel that the present invention is primarily directed.

### SUMMARY OF THE INVENTION

One aspect of the present invention relates to a microchannel for analyte band broadening compensation. A microchannel includes a bend having an inside radius of curvature, an outside radius of curvature and a width. The bend is constructed such that the width and either the inside radius of curvature, the outside radius of curvature or both change simultaneously.

Another aspect of the invention relates to a microchannel for analyte band broadening compensation. The microchannel includes a first working section, a second working section, remote from the first working section, and a redirecting section connecting the first working section to the second working section. The redirecting section includes a bend having a width that changes simultaneously with an inside radius of curvature, an outside radius of curvature, or inside and outside radii of curvature, and a counter bend.

In yet another aspect the present invention is directed to a microchannel for analyte band broadening compensation. The microchannel includes a first working section, a second working section remote from the first working section and a redirecting section connecting the first and second working sections. The redirecting section, the first working section and the second working section define a pathway and the redirecting section is constructed and arranged to define a total angular displacement along the pathway of greater than about 340°.

The microchannel of the present invention results in a number of advantages over other microchannels and microfluidic devices known in the art. For example, the microfluidic channel, including the bends or turns, of the present invention may be fabricated utilizing conventional molding, embossing, and etching techniques, such as, but not limited to, reactive-ion etching (RIE). Moreover, because of the turns or bends and junctions, such as tapered sections, are constricted over relatively short distances, they do not lead to excessive increases in electrical resistance and Joule heating.

An additional advantage of the microfluidic channel of the present invention relates to the bend or curved portion of the microfluidic channel. Several known channel designs require either two opposite bend sections that must be followed almost immediately by one another to avoid translational diffusion, or wide microchannel widths in order to compensate for the race track effect. In accordance with the present invention, a single bend section may be utilized, which reduces space and offers the option of significantly longer linear sections or working sections rather than serpentine channels, if desired. In addition, and in accordance with the present invention, the redirecting section or bend section width need not be widened above the normal working channel width in order to compensate for substantially all of the analyte plug skewing as a result of the analyte plug traversing the bend or turn.

Additional features and advantages of the invention will be set forth in the detailed description which follows and in part will be readily apparent to those skilled in the art from a description or recognized by practicing the invention as described herein.

It is to be understood that both the foregoing general description and the following detailed description are merely exemplary of the invention, and are intended to provide an overview or framework for understanding the nature and character of the invention as it is claimed. The accompanying drawings are included to provide further understanding of the invention, illustrate various embodiments of the invention, and together with the description serve to explain the principles and operation of the invention.

### BRIEF DESCRIPTION OF THE DRAWINGS

The invention can be better understood with reference to the following drawings.

FIG. 1 depicts a simulation showing the effect that a conventional microchannel having a 90° bend has on an analyte band plug traversing the bend.

FIG. 2 is a perspective view of a conventional microfabricated device having an open electrophoresis channel and liquid reservoirs formed on a substrate.

FIG. 3 depicts a first preferred embodiment of the microchannel in accordance with the present invention.

FIG. 4 depicts a second preferred embodiment of a microchannel in accordance with the present invention.

FIG. 5 schematically depicts a simulation showing the plug shape after an analyte band plug has traversed the redirecting section of the microchannel depicted in FIG. 3.

FIG. 6 schematically depicts a simulation showing the plug shape after an analyte band plug has traversed the redirecting section of the microchannel depicted in FIG. 4.

FIG. 7 graphically depicts an XY plot of the leading concentration edge of an analyte band plug after a simulation has allowed the plug to completely traverse the redirecting section in accordance with the present invention.

FIG. 8 depicts a third preferred embodiment of a microchannel in accordance with the present invention.

### DETAILED DESCRIPTION OF THE INVENTION

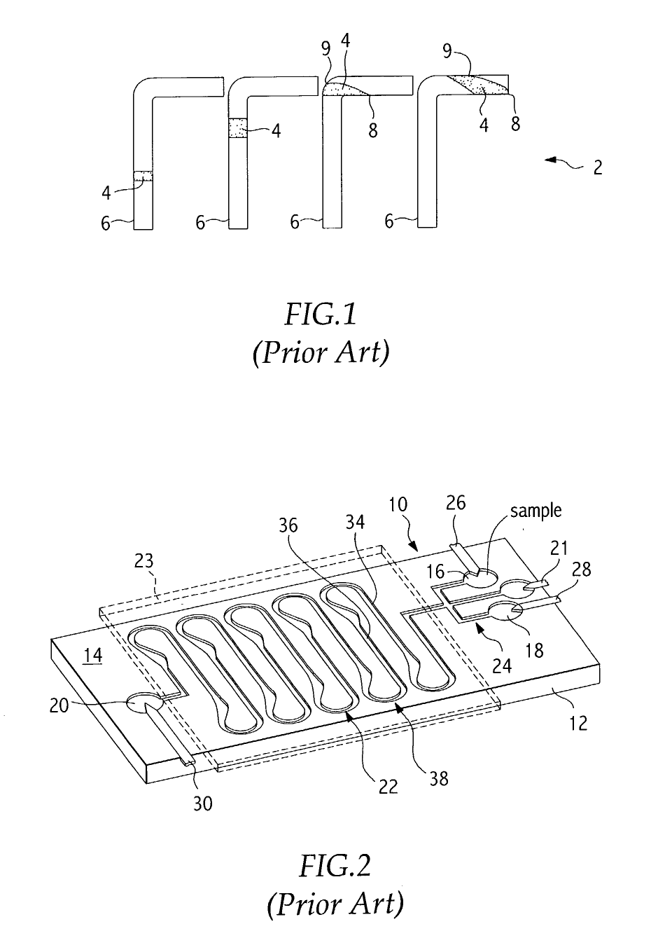

As discussed briefly above, the “race track effect” in microchannels, particularly microfluidic channels, used in performing high-resolution electrophoretic separations is a known problem induced by bends or turns in the microchannels. Generally speaking, the race track effect results in band broadening of an analyte plug traversing the bend or turn. The simulation depicted in FIG. 1 shows the dispersion or “race track effect” experienced by an analyte plug at various locations through a 90° turn. Simulation 2 depicts representations of analyte plug 4 passing through microchannel 6 having a 90° bend as analyte plug 4 traverses the bend. Before entering the bend, analyte plug 4 has a leading edge 8 and a lagging edge 9 that are substantially aligned with each other along the anlyte plug 4 axis which is oriented substantially normal to the microchannel 6 wall preceding the bend. As analyte plug 4 approaches and traverses the turn in microchannel 6, the molecules making up the band plug 4 will migrate through the shorter inner side of the bend portion of microchannel 6, then through the longer outer side of the bend portion of microchannel 6, leading to band spreading and non-uniformity across the width of the channel. As a result, analyte plug 4 exhibits a skewed profile where the leading edge 8 of plug 4 is ahead of the lagging edge 9 of plug 4 within microchannel 6 after plug 4 has cleared the bend portion of microchannel 6. Generally speaking, two different phenomena are responsible for this effect. One is simply the distance traveled by the two outside band edges 8, 9 around the curve or bend. The second is the electric field strength which exacerbates the first. Generally speaking, the electric field strength present around the bend is at a maximum on the interior surface of the curve and decreases as the distance away from the radius of the inner channel wall is increased. Accordingly, the amount by which the leading edge 8 leads lagging edge 9 is a function of the angle, width and radius of the curve of the microchannel.

A conventional microfabricated device 10 utilized to compensate for the “race track effect” in electrophoretic separations is shown in FIG. 2. Device 10 generally includes a planar substrate 12 having formed in its upper surface 14 open reservoir 16, 18, 19, and 20, and a serpentine electrophoresis channel 22 connecting the reservoirs 18 and 16, which are intended to contain electrophoresis buffer and sample fluid, respectively, are connected in fluid communication with each other and with channel 22 through a fork-like connector 24. Reservoirs 19, 20 are intended to maintain electrical continuity for the separation. The four reservoirs are connected to electrodes 26, 28, and 21, and 30, as shown, which are in turn connected to suitable voltage leads during operation of the device, for (i) loading sample from reservoir 16 into channel 22, by applying a voltage across electrodes 26, 28, and (ii) electrophoretically separating charged sample components, by applying a voltage difference across opposite ends of the channel, i.e,. across electrodes 21, 30.

With continued reference to FIG. 2, channel 22 further includes a plurality of parallel linear channel segments, such as segments 32, 34, and 36, and curved channel regions connecting the adjacent ends of the adjacent linear segments, such as curved channel region 38 connecting adjacent ends of segments 32, 34. In a typical embodiment, the substrate or chip has side dimensions of about 1 to 15 cm, and the linear segments are each about 0.5 to 10 cm in length. Thus, for example, a channel having 30 linear segments each about 8 mm in length has a column length, ignoring the lengths of the connecting regions of about 250 mm. With the added lengths of the connecting regions, the total length may be in the 30 cm range on a chip whose side dimensions may be as little as 1 cm. A cover slip 23 placed over the portion of the substrate having the serpentine channel serves to enclose the channel, although an open serpentine channel may alternatively be employed.

In the device 10 depicted in FIG. 2, the particular design of curved region 38 is intended to compensate for the “race track effect” in electrophoretic separations conducted within channel 22 of device 10. Generally speaking, curved region 38 is formed by two turn segments which result in a net 180° turn in curved region 38. Further details relating to the particular microchannel design depicted in FIG. 2 can be found in U.S. Pat. No. 6,176,991, which issued on Jan. 23, 2001. While the device 10 depicted in FIG. 2 may minimize the “race track effect” or band skewing, it is not optimized and therefore does not adequately compensate for band skewing when the microchannel dimensions are other than those disclosed in U.S. Pat. No. 6,176,991.

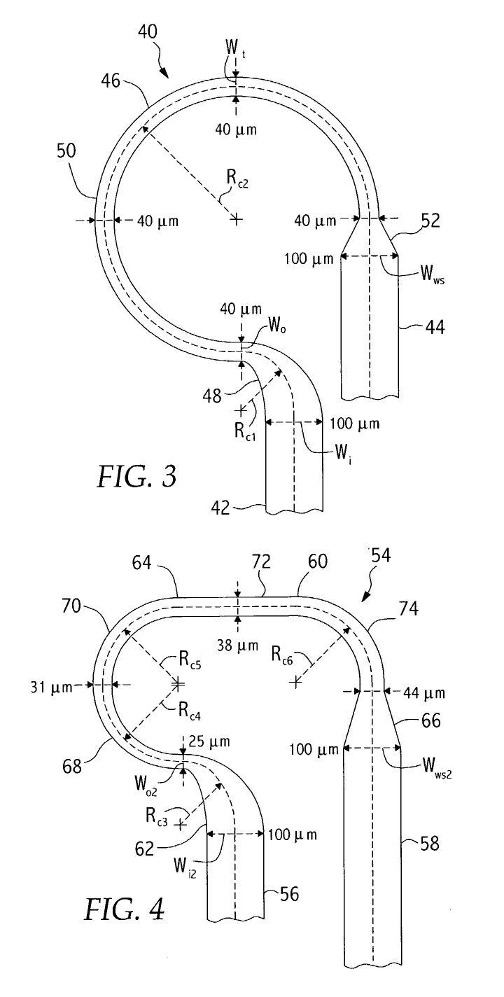

Reference will now be made in detail to the present preferred embodiments of the invention, examples of which are illustrated in the accompanying drawing figures. Wherever possible, the same reference numerals will be used throughout the drawing figures to refer to the same or like parts. An exemplary embodiment of the microchannel of the present invention is depicted in FIG. 3 and is designated generally throughout by reference numeral 40.

Generally speaking, exemplary microchannel 40 depicted in FIG. 3 preferably includes a first working section 42, a second working section 44, both of which are preferably straight or linear sections, and a redirecting section 46 connecting the first and second working sections. In accordance with the present invention, redirecting section 46 provides a pathway for the redirection of a sample fluid, in particularly one or more analytes in a sample mixture during electrophoretic separation. Redirecting section 46 preferably includes a bend 48 depending from first working section 42, followed by a counterbend 50, which turns redirecting section 46 in a direction opposite bend 48, preferably followed by a tapered section 52 that communicates with second working section 44.

More specifically, a preferred exemplary microchannel 40 may include a first working section 42 having a width of between about 50.0 microns to about 200.0 microns. The bend 48 in fluid communication with first working section 42 may preferably define a 90° turn having a varying average radius of curvature or centerline radius of curvature R_{c1} that preferably increases from first working section 42 to second bend 50. Accordingly, first bend 48 may preferably be tapered from a width equal to the width of first working section 42 to a width equal to between about 15% and about 50% of the first working section 42 width. Thus, in the preferred embodiment of microchannel 40 depicted in FIG. 3, where the first working section 42 width is 100.0 microns, first bend 48 may be optimized to include an inlet width W₁ of approximately 100.0 microns, an outlet width Wₒ of approximately 40.0 microns, and an R_{c1} value increasing from about 100.0 microns to about 130.0 microns in the direction of fluid flow.

First bend 48 may preferably be immediately followed by counterbend 50 defining a 270° counterturn having a constant centerine radius of curvature R_{c2} and a constant width. Thus, for the optimized microchannel 40 depicted in FIG. 3, counterbend 50 has an R_{c2} of approximately 263.0 microns and a constant width Wₜ of approximately 40.0 microns.

Tapered section 52, preferably in fluid communication with the end of counterbend 50 remote from bend 48, is preferably a straight section that is gradually tapered to return microchannel 40 to the working section width (in this case 100.0 μm). In a case of preferred microchannel 40 depicted in FIG. 3, tapered section 52 preferably increases in width from the counterbend width Wₜ (in this case 40 μm) to second working section width W_{ws} (in this case 100 μm). In a preferred embodiment, tapered section 52 preferably defines a length of approximately 125.0 microns having a width that increases linearly along its length. In a preferred embodiment, second working section 44 preferably has a width W_{ws} that is equal to or substantially equal to the width of first working section 42. Accordingly, the width of second working section 44 may be between about 50.0 microns to 200.0 microns. In accordance with the optimized microchannel depicted in FIG. 3, W_{ws} of second working section 44 is preferably 100.0 microns.

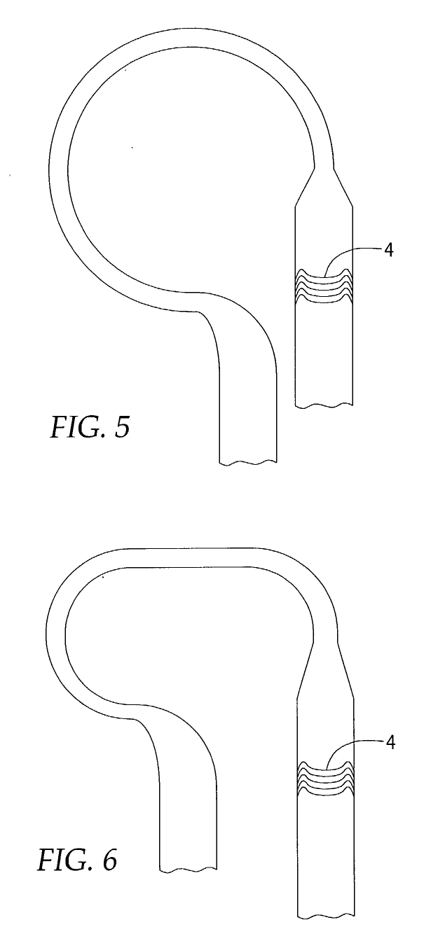

A second exemplary microchannel 54 is depicted in FIG. 4. Generally speaking, microchannel 54 includes a first working section 56, a second working section 58, both of which are preferably straight or linear sections, and a redirecting section 60 connecting the first and second working sections. In accordance with the present invention, redirecting section 60 provides a pathway for the redirection of a sample fluid, in particular one or more analytes in a sample mixture during electrophoretic separation. Redirecting section 60 preferably includes a bend 62 depending from first working section 56, followed by a counterbend 64 which turns redirecting section 60 in a direction opposite bend 62, preferably followed by a tapered section 66 that communicates with second working section 58. In a preferred embodiment, counterbend 64 of microchannel 54 may preferably include a plurality of distinct sections. As depicted in FIG. 4, second bend 64 may preferably include a first counterturn 68 following and communicating with bend 62, followed by a second counterturn 70, followed by straight portion 72, followed by a third counterturn 74, which communicates with tapered section 66. Although other configurations may be employed in accordance with the present invention, the one or more counterturns embodied by counterbend 64 preferably results in a 270° turn in a direction opposite of the direction of first bend 62.

In the second preferred embodiment of microchannel 54 depicted in FIG. 4, first working section 56 may also have a width of about 50.0 microns to about 200.0 microns. First bend 62 in fluid communication with first working section 56 may preferably define a 90° turn having a varying average radius of curvature or centerline radius of curvature R_{c3} that preferably increases from first working section 56 to first counterturn 68. Accordingly, bend 62 may preferably be tapered from a width equal to the width of first working section 56 to a width equal to between about 15% to about 50% of the first working section 56 width. Thus, for the second preferred embodiment of microchannel 54 depicted in FIG. 4, wherein first working section 56 has a first working section 56 width of 100 microns, bend 62 has been optimized to include an inlet width Wᵢ₂ of approximately 100.0 microns, an outlet width Wₒ₂ of approximately 25.0 microns, and an R_{c3} value increasing from 100.0 microns to 137.5. microns in the direction of fluid flow.

In addition, first counterturn 68 preferably follows and communicates with bend 62 and defines a 90° turn opposite the direction of the turn defined by bend 62. The width of first counterturn 68 preferably increases from 25.0 microns at the beginning of first counterturn 68 to 31.0 microns at the end of first counterturn 68 and has an centerline radius of curvature R_{c4} that decreases from 132.50 microns to 129.50 microns. Second counterturn 70 also defines a 90° turn in the same direction as first counterturn 68 and also has a width that is constantly increasing from 31.0 microns at the beginning of the turn to 38.0 microns at the end of the turn. The centerline radius of curvature R_{c5} of second counterturn 70 also decreases from 129.50 microns at the beginning of the turn to 126.0 microns at the end of the turn. Straight portion 72 communicating with second counterturn 70 preferably has a constant width of approximately 38.0 microns and preferably extends a length of about 150.0 microns between second counterturn 70 and third counterturn 74.

Third counterturn 74 preferably defines a 90° turn in the same direction as first counterturn 68 and second counterturn 70, and preferably has a width that continuously increases from 38.0 microns at the beginning of the turn to 44.0 microns at the end of the turn. Again, the average radius of curvature R_{c6} continuously decreases from 126.0 microns at the beginning of the turn to 123.0 microns at the end of the turn. Third counterturn 74 preferably communicates with straight portion 72 that is tapered to return redirecting section 60 to the working channel width. Thus, for the optimized microchannel 54 depicted in FIG. 4, tapered section 66 preferably has a channel width that is constantly increasing from 44.0 microns to 100.0 microns over a length of approximately 125.0 microns. Although second working section 58 may also have a width of between about 50.0 microns to about 200.0 microns, the second working section 58 width W_{ws2} is 100.0 microns.

The microchannels of the present invention are preferably manufactured on a glass substrate using conventional etching techniques such as, but not limited to, reactive-ion etching (RIE). Generally speaking, the specific design criteria for the microchannels of the present invention such as the optimized microchannels 40 and 54 depicted in FIGS. 3 and 4, respectively, may be determined using commercially available software packages such as, “Gambit,” compiled by Fluent, Inc. and “Fluent,” compiled by Fluent, Inc. Two-dimensional microchannel designs may first be constructed in Gambit and then imported into the Fluent fluid modeling package in order to simulate an analyte plug flow through the microchannel with respect to the electrophoretic field applied across the inlet and outlet of the designed microchannels of the present invention. Knowing the steady-state voltage field and electric field at various locations along the microchannel, the flow under electrophoretic conditions may be analyzed. In both the microchannel 40 depicted in FIG. 3 and microchannel 54 depicted in FIG. 4, bend 48 and 62, respectively, create the skew to be corrected for in counterbend 50 and 64, respectively. A specific example of operable dimensions for microchannel 54 depicted in FIG. 4 are presented in Table 1 which follows below. Determining the proper amount of taper for the various portions of redirecting section 62 depends upon all of the parameters of each turn including the average (or centerline) radius of curvature, average width and angle of the turn, and has been previously described by the following equation:

α₁R₁w₁²=α₂R₂w₂²

Further details relating to the application of the above-mentioned equation may be found in Mulho, J. I., Herr, A. E., Mosier, B. B., Santiago, J. G., Kenny, T. W., Brennen, R. A., Gordon, G. G., and Mohammadi, V., Anal. Chem. 73 (2000), which is hereby incorporated herein by reference.

TABLE 1

| | | | |
|---|---|---|---|
| Centerline | | Avg. | Avg. Radius of |
| Radius (μm) | Width (μm) | Width | Entire Turn |

| | End 1 | End 2 | End 1 | End 2 | Angle | (μm) | (μm) |
|---|---|---|---|---|---|---|---|
| Turn 1 | 100 | 137.5 | 100 | 25 | 90° | 62.5 | 118.8 |
| Turn 2 | 132.5 | 129.5 | 25 | 31 | −90° | 28.2 | 130.9 |
| Turn 3 | 129.5 | 126 | 31 | 38 | −90° | 34.5 | 127.8 |
| Turn 4 | 126 | 123 | 38 | 44 | −90° | 40.8 | 124.6 |

Generally speaking, the radius of curvature (R_{c}) may preferably be determined as the average or centerline radius of curvature between the radius of the inside and outside channel walls. The design for microchannel 54 of the present invention was determined by describing the geometry of bend 62 and then choosing general desires for the geometry of counterbend 64 and included the step of varying the radius of curvature for the outside channel wall until a solution was found to coincide with the electric fields compensating one another.

An alternative solution to solving the equation set forth above is solved by microchannel 40 depicted in FIG. 3. The design may preferably be arrived at by holding the radius of curvature of the outside wall of counterbend 50 of microchannel 40 constant and solving for the necessary width to taper down to around bend 48 so that the width of the channel may be held constant around counterbend 50. The preferred embodiment depicted in FIG. 3 thus included a bend 48 tapering down to a width of 40.0 microns and the radius of curvature for the outside wall of counterbend 50 may then be maintained at a constant 263.0 microns

Simulation results demonstrating the analyte band skew compensation provided by microchannels 40 and 54 depicted in FIGS. 3 and 4, respectively, are shown in FIGS. 5 and 6, respectively. Each of FIGS. 5 and 6 depict the analyte plug 4 shape after analyte plug 4 has traversed microchannels 40 and 54, respectively. In both cases, analyte plug 4 returned to a plug profile having a plug profile axis that is perpendicular to the microchannel walls. Essentially, after traversing redirecting sections 46 and 60, analyte plug 4 has neither a leading edge 8, nor a lagging edge 9.

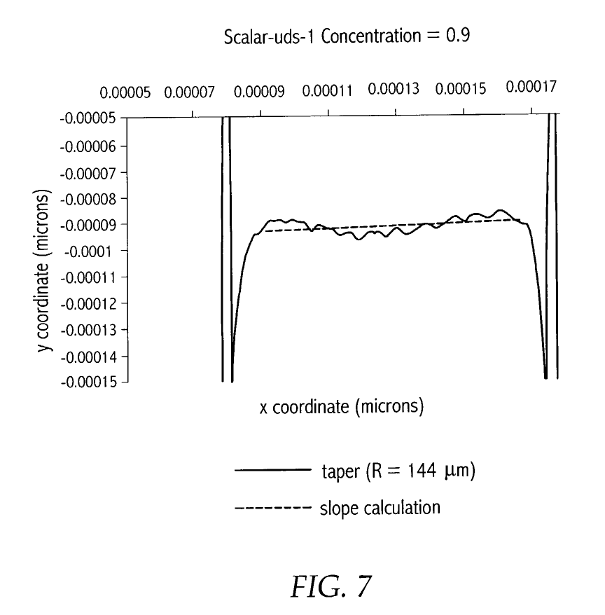

The amount of analyte plug band skew remaining after band skew compensation in accordance with the present invention may also be characterized with reference to the plot depicted in FIG. 7. FIG. 7 depicts a plot of the leading edge of an analyte plug in XY coordinates. The values of the slopes of the skew for different microchannel geometries including those depicted in FIGS. 3 and 4 are set out in the following table.

TABLE 2

| Channel Design | Slope |
|---|---|
| 20 μm constant width design (FIG. 3) | −0.505 |
| 25 μm constant width design (FIG. 3) | −0.344 |
| 40 μm constant width design (FIG. 3) | +0.095 |
| 144 μm outside radius of curvature design | +0.060 |
| (FIG. 4) | |
| Known skew minimizing design | +0.135 |
| 180° turn with 150 μm R_{c} | +6.64 |

Given that the objective is for the analyte plug front to be perpendicular to the second working section walls after the analyte plug has traversed the redirecting section of the microchannel, a slope of 0.0 is the target. Referring now to Table 2, one of skill in the art will readily recognize that microchannel 54 depicted in FIG. 4 has a slope closest to 0.0, and is thus the most preferred embodiment for anlayte band plug compensation of the embodiments listed in Table 2. A close second is microchannel 40 depicted in FIG. 3 as it has a slope of +0.095, only 0.035 greater than the slope of an analyte band plug passed through microchannel 54 depicted in FIG. 4. As the analyte plug front shape deviates more from perpendicular with respect to the working section walls, the slope becomes larger and the sign of the slope indicates whether or not the leading edge is the inner (+) or outer (−) side of the plug. In general, the slopes provided in Table 2 indicate a significant improvement over known analyte plug compensation microchannel designs which have slopes as high as, and in some instances higher than, +0.135x.

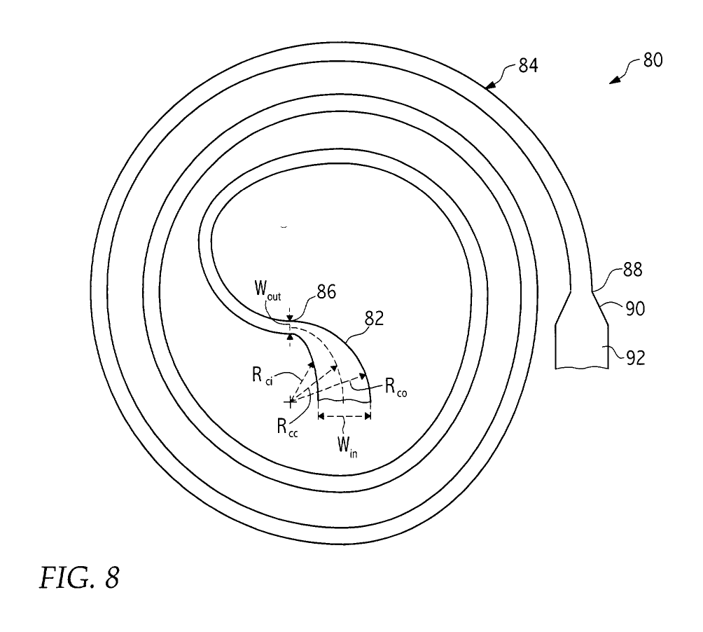

While the specific details of two optimized microchannels 40 and 54 have been described above with reference to FIGS. 3 and 4, one of ordinary skill in the art will readily recognize that numerous other designs may be equally operative in accordance with the present invention. One such microchannel 80 is depicted in FIG. 8. As depicted clearly in the drawing figure, microchannel 80 has a substantially spiral configuration. In accordance with the present invention, one of ordinary skill in the art may readily employ the, “Gambit,” and “Fluent” software packages and the equation (α₁R₁w₁²=α₂R₂w₂²) described above to arrive at the specific design criteria for microchannel 80.

As may be recognized from the wide variety of embodiments disclosed and depicted herein, any number of microchannel designs/configurations may be operable in accordance with the present invention. Preferably, each such design/configuration share certain common elements or features. More specifically, a given microchannel for analyte band broadening compensation in accordance with the present invention may preferably include a bend 82 having an inside radius of curvature R_{c1}, an outside radius of curvature R_{co}, and a width that continuously varies between an inlet width_{Win} and an outlet width Wₒᵤₜ. Bend 82 is preferably constructed such that the width and either the inside radius of curvature, R_{ci}, the outside radius of curvature, R_{co}, or both R_{ci} and R_{co} change simultaneously. In the preferred embodiments depicted in FIG. 3, 4 and 8, that width preferably decreases and thus bend 82 is a reducing taper. In addition, bend 82 and bends 48 and 62 depicted in FIG. 3 and 4, respectively, effect a 90° turn in each of the preferred embodiments. One of skill in the art will recognize, however, that bend 82, 48 and 62 are in no way limited to a 90° turn. Smaller and greater angles may also be utilized to facilitate analyte band broadening compensation in accordance with the present invention, but such angles may significantly affect the other aspects and features of the microchannel of the present invention.

Referring again to FIG. 8, the centerline radius of curvature, R_{cc} is indicated to depict the location of the average radius curvature of bend 82. As discussed briefly above, one of ordinary skill in the art may utilize the centerline radius of curvature R_{c}C rather than the inside radius of curvature R_{c}I and the outside radius of curvature R_{c}O to optimize the design elements of microchannel 80. For the embodiment depicted in FIG. 8, one of skill in the art will further understand that the counterbend 84 of microchannel 80 preferably includes that portion of microchannel 80 extending from outlet 86 of bend 82 to the inlet 88 of a tapered section 90 connecting counterbend 84 with a working section 92. Moreover, it may be readily recognized that bend 82 and counterbend 84 depicted in FIG. 8 represent a redirecting section capable of redirecting the flow of an analyte band plug through a pathway that undergoes a total angular displacement measuring approximately 1080°. The first 90° angular displacement is preferably in a counterclockwise direction, while the second angular displacement follows in a clockwise direction covering an angular displacement of about 990°. In each of the embodiments, the initial bend (such as bend 48, 62, or 82) actually creates an analyte band plug skew, while the counterbend (such as counterbend 46, 64, or 84) returns the analyte band plug to its substantially original shape, thus compensating for the racetrack effect.

While the invention has been described in detail, it is to be expressly understood that it will be apparent to persons skilled in the relevant art that the invention may be modified without departing from the spirit of the invention. Various changes of form, design or arrangement may be made to the invention without departing from the spirit and scope of the invention. Therefore, the above mentioned description is to be considered exemplary, rather than limiting, and the true scope of the invention is that defined in the following claims.

What is claimed is:

1. A microchannel for analyte band broadening compensation, the microchannel comprising:
a bend including an inside radius of curvature an outside radius of curvature and a width, the bend constructed such that the width and either the inside radius of curvature, the outside radius of curvature or both change simultaneously.

2. The microchannel of claim 1 further comprising a counterbend communicating with and following the bend, wherein the bend and the counterbend define a total angular displacement of greater than about 90 degrees.

3. The microchannel of claim 2 wherein the total angular displacement measures greater than about 340 degrees.

4. The microchannel of claim 1 further comprising a counterbend communicating with and following the bend, wherein the bend and the counterbend together define a net 180 degree turn.

5. The microchannel of claim 1 wherein the width of the bend is continuously decreasing.

6. The microchannel of claim 4 wherein the bend comprises at least one turn totaling 90 degrees in a first direction and the counterbend comprises at least one turn totaling 270 degrees in a second direction opposite the first direction.

7. The microchannel of claim 4 wherein the bend comprises at least one turn totaling 90 degrees in a first direction and the counterbend comprises a plurality of turns totaling 270 degrees in a second direction opposite the first direction.

8. The microchannel of claim 2 further comprising a tapered section following the counterbend and a working section following the tapered section, the tapered section defining a width that continuously increases from the counterbend to the working section.

9. A microchannel for analyte band broadening compensation, the microchannel comprising:
a first working section:
a second working section remote from the first working section; and
a redirecting section connecting the first working section to the second working section, the redirecting section including a bend having a width that changes simultaneously with an inside radius of curvature, outside radius of curvature or inside and outside radii of curvature, and a counterbend.

10. The microchannel of claim 9 wherein the redirecting section defines a total angular displacement of greater than 90 degrees.

11. The microchannel of claim 10 wherein the total angular displacement measures greater than 340 degrees.

12. The microchannel of claim 9 wherein the width of the bend decreases continuously from the first working section to the counterbend.

13. The microchannel of claim 9 further comprising a tapered section connecting the counterbend to the second working section.

14. The microchannel of claim 13 wherein the tapered section defines a width that is continuously increasing from the counterbend to the second working section.

15. The microchannel of claim 9 wherein the bend defines a 90 degree turn in a first direction and wherein the counterbend defines at least one turn totaling 270 degrees in a second direction opposite the first direction.

16. A microchannel for analyte band broadening compensation, the microchannel comprising:
a first working section;
a second working section remote from the first working section; and
a redirecting section connecting the first and second working sections, the redirecting section constructed and arranged to define a total angular displacement of greater than about 340 degrees.

17. The microchannel of claim 16 wherein the redirecting section comprises a plurality of turns having a total angular displacement that is equal to or greater than 360 degrees.

18. The microchannel of claim 16 wherein the redirecting section comprises a bend in one direction and a counterbend in a direction opposite the first direction.

19. The microchannel of claim 18 wherein the bend defines a continuously changing width and an inside radius of curvature, and an outside radius of curvature, and wherein the bend is constructed such that at least one of the inside radius of curvature, the outside radius of curvature or both and the width change simultaneously.

20. The microchannel of claim 18 wherein the counterbend comprises a plurality of turns in the same direction.
